(19) United States
(12) Patent Application Publication
(10) Pub. No.: US 2020/0175387 A1
(43) Pub. Date: Jun. 4, 2020

(54) HIERARCHICAL DYNAMIC DEPLOYMENT OF AI MODEL

(71) Applicant: International Business Machines Corporation, Armonk, NY (US)

(72) Inventors: Alan BRAZ, Bedford Hills, NY (US); Martin Hirzel, Ossining, NY (US); Todd Mummert, Danbury, CT (US); Jason Tsay, Yorktown Heights, NY (US); Peter Westerink, Ossining, NY (US)

(21) Appl. No.: 16/205,329

(22) Filed: Nov. 30, 2018

(51) Int. Cl. G06N 5/02

(52) U.S. Cl. CPC G06N 5/022

(57) ABSTRACT

A method of deploying artificial intelligence (AI) model resources includes storing at least one AI model in a model store memory in a plurality of different versions, each different version having a different level of fidelity. When a request to exercise the AI model is received, a processor determines which version of the AI model to exercise for the received request. The determined AI model version is used to serve the received request by exercising input data accompanying the received request. The result of the exercised AI model version is used to respond to the received request.

### BACKGROUND

The present invention relates generally a service that executes artificial intelligence (AI) models upon requests from users and, more specifically, a computer solution platform stores AI models at different compression levels from low to high fidelity with an associated performance metric, so that a user can choose a response policy based on a tradeoff between speed of response versus performance accuracy for requests for processing an AI model for that user.

### SUMMARY

A prediction service is an online service that is available to users via a prediction request that includes data for a requested prediction in view of the input data submitted with the request. For example, a user might make a request to a prediction service with image data from a camera, requesting that the prediction service to process an AI model to classify one or more objects in the image data. The user making a prediction request is not necessarily a human user, since a web camera might be programmed to automatically make a request to an image classification prediction service for a prediction of image data.

The problem recognized by the present inventors is that, when machine learning models, which can be large models, are served through a prediction service with a large number of potential models to serve, a new request may involve a model not currently resident in memory. The prediction service must then load the appropriate model, which often takes a significant amount of memory. The prediction service may even need to evict another resident model in order to load the newly requested model. This loading and evicting may take a long time if the model is large, resulting in high latency for the prediction service to respond to the user's prediction request, thereby resulting in an unfavorable user experience. This latency of service is known in the art as the “cold start” problem. This problem is compounded in environments with many potential servable models, as often models must also be evicted from the resident memory before a new incoming request can be processed.

Existing solutions either assume a limited number of not-so-large models so that all models are always resident in memory and/or assume that loading of an entire model into memory is necessary and therefore inherently more susceptible to the “cold start” problem.

According to an exemplary embodiment, the present invention provides a method (and apparatus and computer product) for managing and deploying AI models, including storing at least one artificial intelligence (AI) model in a model store memory in a plurality of different versions, each different version having a different level of fidelity; receiving a prediction request to process the AI model; determining, using a processor on a computer, which version of the AI model to use for processing the received prediction request; using the processor to process input data accompanying the received prediction request, using the determined version of the AI model; and responding to the received prediction request with a result of the processing of the input data using the determined AI model version.

Also described herein is a method (and apparatus and computer product) of managing AI model deployment, including storing at least one artificial intelligence (AI) model in a model store memory in a plurality of different versions, each different version having a different level of fidelity, including an original version with no loss of fidelity; receiving a request from a user to process the AI model, the request including input data to be processed by the AI model; determining, using a processor on a computer, which version of the AI model to use for responding to the user request; processing the input data using the determined version of the AI model; and providing a result of the processing to the user in response to the request, wherein the determining which version of the AI model to use comprises implementing at least one of: a determination policy preselected by the user; a preset eviction/loading policy that determines whether to evict an AI model currently in a resident memory to accommodate the received request and, if so, which AI model to evict; and a preset policy that implements a preset tradeoff involving predetermined ones of any of: a latency, a model performance (accuracy), a confidence, a memory usage, a power consumption, a central processing unit (CPU) usage, and a consideration of a concurrent processing.

Also described herein is a method (and apparatus and computer product) in a prediction service, including storing a plurality of artificial intelligence (AI) models in a model store memory, each AI model being stored in a plurality of different versions, each different version having a different level of fidelity, including an original version with no loss of fidelity; receiving a prediction request for processing a requested AI model of the plurality of AI models, the prediction request including input data for the processing of the requested AI model; determining, using a processor on a computer, which version of the requested AI model will be used to process the input data included with the prediction request and whether the version needs to be loaded from the model store memory into a resident memory for processing the input data; when the requested AI model version is to be loaded from the model store memory into the resident memory, determining whether another AI model currently resident in the resident memory will need to be evicted from the resident memory to accommodate moving the version of the requested AI model into the resident memory, and, if so, determining which currently-resident AI model will be evicted to accommodate the received request, using a preset eviction/loading policy; processing the input data to provide a prediction result; and responding to the prediction request by transmitting the prediction result.

### BRIEF DESCRIPTION OF THE DRAWINGS

FIG. 1 shows in block diagram format 100 an exemplary embodiment of the present invention;

FIG. 2 shows in flowchart format an exemplary method of the present invention;

FIG. 3 depicts a cloud computing environment according to an embodiment of the present invention; and

FIG. 4 depicts abstraction model layers according to an embodiment of the present invention.

### DETAILED DESCRIPTION

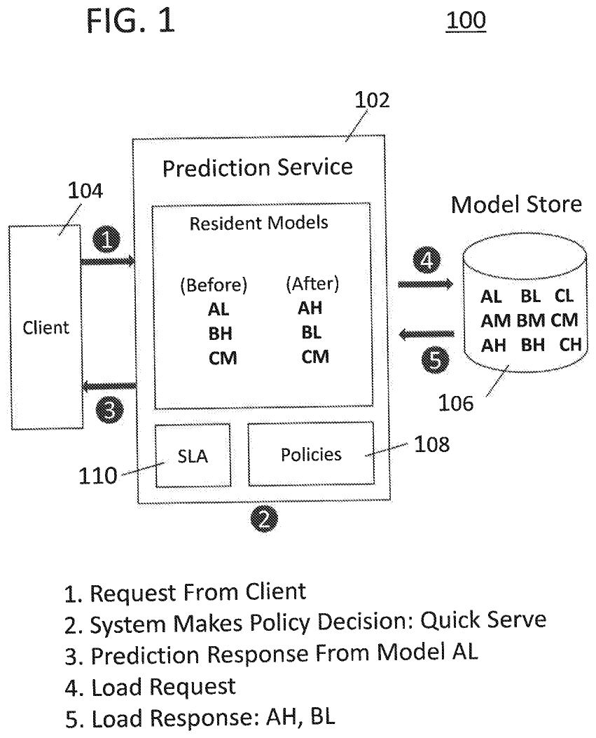

With reference now to FIG. 1, the present invention provides a method by which cold starts at a prediction service 102 can be eliminated or at least reduced based on providing users choices with different policies that permit each user to determine a response policy that defines a tradeoff between response speed and performance. However, prior to describing the method of the present invention in detail, various terms are clarified, as follows.

For purpose of this disclosure, a machine learning or AI (artificial intelligence) model is the result of training of a machine learning or deep learning algorithm. Trained models contain learned weights and biases, and for deep learning models especially, there may be millions of these weights.

Scoring/Prediction is the act of a user 104 sending input data to a served model via a prediction request and receiving a prediction based on the given input data. As mentioned, the user may be something other than a human, such as a web camera.

The term serving/deploying a model means loading a model for a prediction.

The term “cold start” refers to the problem where a user's desired model is not currently in memory and must be loaded in a resource-constrained environment. As models may be large (100 mb to 10 gb), it may take considerable time before the model is loaded and the user's prediction is completed.

Eviction refers to unloading a model currently resident in memory to make room for a new one.

Resident refers to a model as loaded in memory for serving, such models may be large in terms of memory usage.

Fidelity, as used herein, refers to the level of model performance in relation to model compression for a given version of a model. Model performance here refers to measures such as accuracy, precision, recall, Fl-score, etc. Typically, a high-fidelity model is expected to have higher performance and a higher memory footprint, whereas low fidelity has a lower memory footprint but at the cost of performance.

Relative to model compression, compressed models are typically faster and smaller in terms of memory usage than an original model. In relation to fidelity, one would expect that more highly compressed models have a lower fidelity and therefore lower model performance.

To solve this “cold start” problem, the system of the present invention manages the available models and provides several versions of each model in differing levels of compression and fidelity in backend storage, referred to herein as a “model store” 106. The system manages the loading of non-resident models from the model store to resident memory by dynamically determining which models to evict and which models to load based on policies 108, which might involve consideration of service level agreements (SLA) 110 related to various users 104.

For example, one such policy to prioritize quick loading and minimize “cold starts” would be to load a low fidelity version of a model based on user preferences defined by the policy selected by each user. As soon as the low fidelity model is loaded, an initial scoring result can be returned to the user. The system also provides a mechanism for user feedback, for example providing a confidence measure to the user 104.

The user 104 can then request a score from a higher fidelity model based on the confidence of the returned result, as such request could be by default or based on an SLA term. This system is novel because current systems assume a limited number of models and do not consider this problem at all or assume that loading the entire model is necessary, so that long delays to serve a prediction are unavoidable.

In contrast to these current methods, the present invention allows for serving a large number of models with low delay, at a temporary cost, by serving compressed versions of models, at least initially. Thus, the present invention manages deployment of AI models that are compressed at several levels of fidelity and dynamically determines which models to evict from a working memory and subsequently loads a requested model with selected fidelity, from low to high fidelity. The lowest fidelity model can be loaded quickly and, as soon as the low fidelity model is loaded and exercises the data request, a result using the low fidelity model can provide a quick response to the input request. In a preferred embodiment, a scoring result can be included in the quick response so that the user can then request a higher fidelity model be used based on the confidence of the score of the initial returned result, or such higher fidelity transition could be automatic.

This approach is new in the art since current systems assume only a limited number of models or assume that loading the entire model is necessary, which sometimes causes long delay (latency) to serve a prediction for input requests. The system of the present invention allows for serving a large number of models with low delay at a temporary cost of performance, as well as a mechanism that permits accuracy to improve with subsequent requests from that client.

The present invention makes use of model compression techniques that are known in the art. In general, compressed models are faster and smaller models that still approximate the original model. Current model compression techniques occur during or after the training phase. The method of the present invention presumes that, when a model is being trained for presentation at a prediction service, compressed versions are also trained and provided and available for deployment upon request

Various techniques are known in the art for compressing models and include, for example, the method of using pseudo data, the method of pruning the network, and the method of applying singular value decomposition. The present invention does not make a distinction in the compression technique used as long as the resulting model is faster and more compact than the original.

Additionally, the present invention uses a model store 106 that stores multiple versions of available models in various levels of compression or fidelity, including the uncompressed original model. The system also needs to store these models in a retrievable way. An example implementation using existing technologies of this model store would combine a large file storage system such as object storage for storing the actual models, which can be relatively large, with an indexable database for retrieval

As shown in the exemplary embodiment in FIG. 1, the present invention is concerned with the efficient serving of AI models for prediction in a resource-constrained environment where multiple potential models may be served. A client 104, who may be a user or an automated system, first makes a prediction request to the prediction service, in step 1. This prediction service 102 may only have a limited number of models resident, bounded by its available memory, referred to herein as a resident memory used.

Assuming that the model is not loaded in resident memory upon receipt of the client's request, then the system checks its policies 108 and service-level agreement (SLA) 110 to make an appropriate policy decision based on the request Policy decisions here decide which models to evict and load, as in step 2. Based on the policy decision, the system retrieves the appropriate models from the model store, as in step 4.

The model store 106 includes multiple versions of each model at varying levels of compression and fidelity. For example, in FIG. 1, the model store contains three models: A, B, and C, and three versions of each model at low, middle, and high fidelity (AL, AM, AH for model A, and so on).

If the user requests model A and model A is not resident in memory, and the policy decision is to avoid the “cold start” problem, then the system will retrieve a low fidelity version AL of model A from the model store for fast loading and prediction. The low fidelity model AL was resident in memory, so immediate service was rendered to the client in step 3 in the example in FIG. 1.

FIG. 1 also demonstrates a more complicated example of loading a higher fidelity version of a model based on policies In this case, the low fidelity version of A (AL) and the high-fidelity version of B (BH) is already resident in memory in the prediction service. The user requests a prediction against model A and the policy determines that a higher fidelity version of A should be loaded. The system then determines that model B should be swapped out for a low fidelity version (BL) and model A should be swapped out for a high-fidelity version (AH) The system performs this swap and then serves the prediction request against the higher fidelity version of model A. The prediction result may include feedback to the user such as a confidence score so that the user can repeat the request using a higher fidelity version of the model if necessary.

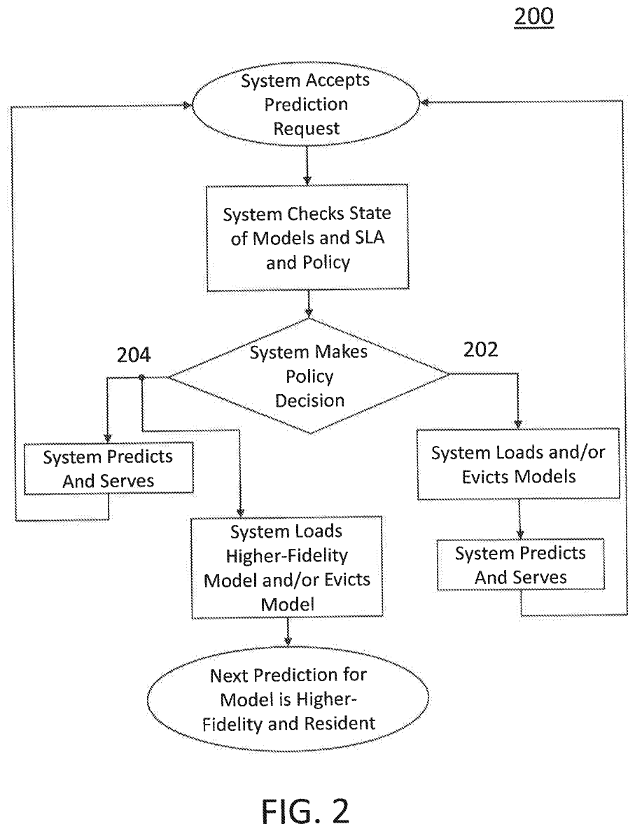

An example of workflow and policy decisions is included in FIG. 2. This exemplary workflow demonstrates two example policies: Quick Serve and Load First, but it should be clear that other versions and variations are possible.

The Load First policy is very simple, the full-size, original model is loaded upon user prediction request If there is not enough memory to load the requested model, other resident models are evicted. The decision of which model to evict may be based on policies, for example, models that are less popular and/or more stale may be more likely to be evicted. Then the prediction is run against the requested model at full fidelity.

The other example policy is Quick Serve which is the policy described throughout much of this disclosure. Upon user request, a low-fidelity model is loaded, if not already resident in memory, and a prediction is quickly run against this low-fidelity model and returned to the user. At the same time, a higher fidelity version of the same model is loaded and if needed, other resident models are evicted. Upon the next user request for the same model, the next prediction will be run against this higher fidelity model. This policy assumes that predictions have temporal locality, that it is likely to have multiple predictions for the same model within a given time frame.

An example application of the present invention may be, for example, image classification for self-driving cars in a prediction service in which the available memory may be limited. During driving, the car's sensors may need a prediction extremely quickly for rare events such as detecting a deer in the road. In this case, a quickly-loaded, low-fidelity version of the model may suffice to avoid the deer but a larger, more common model such as detecting lane markers may still be kept resident in memory.

Other non-limiting examples for tradeoff parameters between time and performance for determining which fidelity AI model to load/execute could include, for example, the size of memory currently available for implementing a current request, the latency time necessary to load an AI model with higher fidelity, the power consumption that would be required to load and execute an AI model with higher fidelity, an expected improvement in performance if a higher-fidelity version were used, including improved accuracy, an expected improvement in confidence for a higher-fidelity version, and a consideration of the priorities of other predictions currently being executed by the prediction service. These tradeoff choices permit a policy to be implemented for permitting a model serving system that is resource-restrained, as all model systems are, and that must deal with loading multiple models, to make use of multiple levels of fidelity of the same AI model to quickly load and serve a model and timely return a prediction to a user.

Another relevant and related mechanism that could be determined by a predetermined policy would be directed to the eviction/loading policies for which AI model to evict that is currently residing in the memory used for storing models available for immediate execution, when a determination is made to move another AI model into that memory for execution. A number of non-limiting polices can be implemented for such eviction decisions, including a first-in/first-out (FIFO) policy, a least-recently-used (LRU) policy, or a policy that considers a potential gain in confidence level or fidelity level between different versions of AI models.

It should be clear from the above description that variations of the invention are possible within the concepts described above.

As a non-limiting first example, a system and apparatus could be implemented to manage the resource footprint of AI models where an AI model is defined as having multiple levels of fidelity, the system determines which level of fidelity is available. If necessary, the system evicts other models and loads the appropriate level of model fidelity.

This first example is concerned with the ability of a model serving system that is resource-constrained, as all model serving systems typically are, and must deal with loading multiple models to make use of multiple levels of fidelity of the same model to quickly load and serve a model and return a prediction to the user. If necessary, the system is also able to decide which models to evict based on the fidelity of the resident models and the fidelity of the requested model that is being loaded.

This first example could be further modified to have the ability to define eviction and loading policies. Thus, system administrators may wish to define specific eviction/loading policies. For example, a system that prioritizes accuracy over latency may have a “load first” policy that always loads original, uncompressed models for prediction and evicts models as necessary. Another example policy for a system may prioritize latency over accuracy is a “quick load” policy that always first loads a low fidelity, compressed model and quickly returns a lower confidence score. The system also then loads a higher fidelity model for subsequent requests.

The first example could be further modified to have the ability to provide prediction confidence feedback to the user. Such feedback may be provided to the user in the form of a confidence score of the prediction of the served model. For example, if the user receives a score from a compressed, low fidelity model, the confidence score may be low. The user may act on this score and then repeat the request which should be served by a higher fidelity model.

The first example could be further modified to have the ability to define policies for various model serving tradeoffs. The main tradeoff in this discussion is the tradeoff between memory usage, latency, model performance (accuracy, etc.), and confidence. Specifically, the present invention provides a mechanism for a system to trade lower latency and lower memory usage for (temporary) degradation of performance and confidence. The same mechanism would allow for other such tradeoffs that are not discussed here including power consumption and concurrent predictions. For example, a system that prioritizes low power consumption may prefer to load versions of models with lower CPU usage and therefore power consumption. The policy system described above may also be used to allow for such tradeoffs. Such additional tradeoffs, even if not explicitly identified herein, are intended as included in the present invention.

Another form of variations includes the actual computer implementation of the invention.

Thus, as shown in FIG. 1, the present invention includes a prediction service 102 associated with a model store 106. It would also to be understood by one of ordinary skill that, although this disclosure includes a detailed description on cloud computing, as follows, implementation of the teachings recited herein are not limited to a cloud computing environment. Rather, as exemplarily shown in FIG. 1, embodiments of the present invention are capable of being implemented in conjunction with any other type of computing environment now known or later developed.

It would also to be understood by one of ordinary skill that although this disclosure includes a detailed description on cloud computing, as follows, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

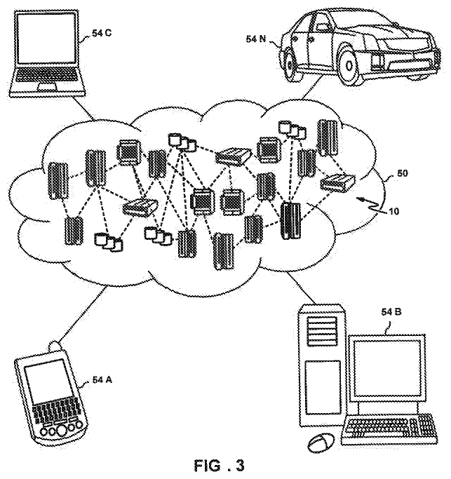

Referring now to FIG. 3, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 3 are intended to be illustrative only and that computing nodes 10 and cloud computing environment 50 can communicate with any type of computerized device over any type of network and/or network addressable connection (e.g., using a web browser).

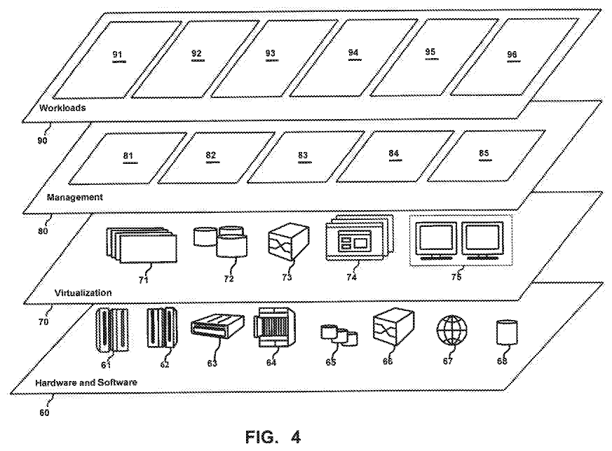

Referring now to FIG. 4, a set of functional abstraction layers provided by cloud computing environment 50 (FIG. 3) is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include tasks related to the implementation of the present invention, such as the receipt of an input request from a user, the determination of which user policy applies for the received request, the determination of which compression version of the requested AI model to use for request, the determination of which model(s) currently in resident memory should be evicted, and the processing of the input data associated with the input request, using the version of the AI model determined as appropriate for the received request.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

While the invention has been described in terms of several exemplary embodiments, those skilled in the art will recognize that the invention can be practiced with modification.

What is claimed is:

1. A method, comprising:
storing at least one artificial intelligence (AI) model in a model store memory in a plurality of different versions, each different version having a different level of fidelity;
receiving a prediction request to process the AI model;
determining, using a processor on a computer, which version of the AI model to use for processing the received prediction request;
using the processor to process input data accompanying the received prediction request, using the determined version of the AI model; and
responding to the received prediction request with a result of the processing of the input data using the determined AI model version.

2. The method of claim 1, wherein the different versions of the AI model comprise the AI model at different levels of compression, including a version having no compression.

3. The method of claim 1, wherein the determining of which version of the AI model to serve for the request is determined by a policy agreed upon by a user making the request, the user thereby selecting a policy that implements a tradeoff between a response speed and a response performance accuracy.

4. The method of claim 1, further comprising:
providing a confidence score to the user; and
providing the user with a mechanism to be served by a higher fidelity version of the AI model.

5. The method of claim 1, wherein the determining of which version of the AI model to use is based on a decision model that implements a tradeoff between any of: a memory usage; a latency in providing a response to the received request; a performance accuracy; a confidence level of the response; a power consumption of the processing; and a consideration of concurrent requests for processing.

6. The method of claim 1, wherein the determining of which version of the AI model to use comprises one or more of:
determining whether any version of the AI model is currently stored in a resident memory of the computer as available and appropriate to process the input data of the received request;
determining whether a version of the AI model stored in the model store memory needs to be served by loading it into the resident memory; and
determining whether an AI model currently resident in the resident memory will need to be evicted from the resident memory and, if so, which currently-resident AI model will be evicted to accommodate the received request.

7. The method of claim 6, wherein the determining of an eviction and a loading is based on a preset eviction/loading policy.

8. The method of claim 7, wherein loading and eviction decisions are determined in accordance with an eviction/loading policy that comprises one of:
a first-in/first-out (FIFO) policy;
a least-recently-used (LRU) policy; and
a potential gain in a confidence level between different versions of an AI model stored in the memory.

9. The method of claim 7, wherein the preset eviction/loading policy comprises a load first policy that always loads an original, uncompressed version of the AI model for a requested prediction and evicts models as necessary, thereby providing a policy of a priority of an accuracy over a latency.

10. The method of claim 7, wherein the preset eviction/loading policy comprises a quick load policy that always first loads a low fidelity, compressed model that quickly returns a lower confidence score.

11. The method of claim 10, wherein the quick load policy further then loads a higher fidelity model for subsequent requests by the user.

12. The method of claim 1, further comprising making a provision for defining a predetermined eviction/loading policy, the predetermined eviction/loading policy comprising one of:
a load first policy that always loads an original, uncompressed model for a prediction and evicts models as necessary, thereby prioritizing an accuracy over a latency; and
a quick load policy that always first loads a low fidelity, compressed model to quickly return a prediction result but with a lower confidence score, while immediately thereafter loading a higher fidelity model for subsequent requests.

13. The method of claim 1, as implemented by a prediction service.

14. The method of claim 1, as implemented as a cloud service.

15. The method of claim 1, as embodied in a set of machine-readable instructions stored in a non-transitory memory device.

16. A method, comprising:
storing at least one artificial intelligence (AI) model in a model store memory in a plurality of different versions, each different version having a different level of fidelity, including an original version with no loss of fidelity;
receiving a request from a user to process the AI model, the request including input data to be processed by the AI model;
determining, using a processor on a computer, which version of the AI model to use for responding to the user request;
processing the input data using the determined version of the AI model; and
providing a result of the processing to the user in response to the request,
wherein the determining which version of the AI model to use comprises implementing at least one of:
a determination policy preselected by the user;
a preset eviction/loading policy that determines whether to evict an AI model currently in a resident memory to accommodate the received request and, if so, which AI model to evict; and
a preset policy that implements a preset tradeoff involving predetermined ones of any of: a latency, a model performance (accuracy), a confidence, a memory usage, a power consumption, a central processing unit (CPU) usage, and a consideration of a concurrent processing.

17. A method in a prediction service, the method comprising:
storing a plurality of artificial intelligence (AI) models in a model store memory, each AI model being stored in a plurality of different versions, each different version having a different level of fidelity, including an original version with no loss of fidelity;
receiving a prediction request for processing a requested AI model of the plurality of AI models, the prediction request including input data for the processing of the requested AI model;
determining, using a processor on a computer, which version of the requested AI model will be used to process the input data included with the prediction request and whether the version needs to be loaded from the model store memory into a resident memory for processing the input data;
when the requested AI model version is to be loaded from the model store memory into the resident memory, determining whether another AI model currently resident in the resident memory will need to be evicted from the resident memory to accommodate moving the version of the requested AI model into the resident memory, and, if so, determining which currently-resident AI model will be evicted to accommodate the received request, using a preset eviction/loading policy;
processing the input data to provide a prediction result; and
responding to the prediction request by transmitting the prediction result.

18. The method of claim 17, wherein the determining of which version of the AI model to use is based on a policy preset by a user who provided the prediction request, the preset policy defining a tradeoff between a speed of receiving the prediction result and a performance of the version of the model for the prediction result.

19. The method of claim 17, wherein the preset eviction/loading policy defines a tradeoff between a lower latency period for loading AI models from the model store memory and a lower memory usage versus a degradation of a performance and confidence of prediction results.

20. The method of claim 17, the preset eviction/loading policy comprising one of:
a first-in/first-out (FIFO) policy;
a least-recently-used (LRU) policy; and
a policy that considers a potential gain in confidence level or fidelity level between different versions of AI models.
